(19) United States
(12) Patent Application Publication
(10) Pub. No.: US 2020/0142963 A1
(43) Pub. Date: May 7, 2020

(54) APPARATUS AND METHOD FOR PREDICTING RESPONSE TO AN ARTICLE

(71) Applicant: Institute For Information Industry, Taipei (TW)

(72) Inventors: Ping-I CHEN, Taipei City (TW); Yen-Heng TSAO, New Taipei City (TW); Chu-Chun HUANG, Taipei City (TW); Yu-Liang SHYU, Taipei City (TW); Pei-Ching LEE, Tainan City (TW)

(21) Appl. No.: 16/203,564

(22) Filed: Nov. 28, 2018

(30) Foreign Application Priority Data
Nov. 1, 2018 (TW) 107138819

(51) Int. Cl. G06F 17/27; G06F 17/15; G06N 20/00

(52) U.S. Cl. CPC G06F 17/2785; G06F 17/15; G06Q 50/01; G06N 20/00; G06F 17/2765

(57) ABSTRACT

An apparatus for predicting response to an article includes a storage, an input interface, and a processor. The storage stores a response prediction model, and the input interface is configured to receive an article to be predicted. The processor is electrically connected to the storage and the input interface, and performs the following operations: analyzing the article to be predicted to obtain its article content; predicting a response generated after the article to be predicted being read according to the response prediction model and the article content; and generating response data according to the predicted response.

### PRIORITY

This application claims priority to Taiwan Patent Application No. 107138819 filed on Nov. 1, 2018, which is hereby incorporated by reference in its entirety.

### FIELD

The present invention relates to an apparatus and method for predicting response to an article. Specifically, the present invention relates to an apparatus and method which determine possible response to an article by analyzing the content of the article.

### BACKGROUND

With the rapid development of social networks, various social platforms (e.g., Facebook) have been developed vigorously, and brand enterprises or public relations corporations need to manage contents related to the brand thereof (e.g., fan pages) on various social platforms, and rapidly accumulate popularity and customers of the brand via articles published on the social platforms.

For the articles published on the platforms, various social platforms provide diversified evaluation/response manners for users to choose. For example, in addition to the common “thumbs-up”, the social platform facebook further provides five expression symbols (which are respectively loved, sad, happy, scared and angry) as a manner of giving response by the users. As indicated by some relevant researches, as compared to numbers of general “thumbs-up” and analyzing meaning of characters responded, expression symbols responded by the users (e.g., facebook expression symbols) usually can more effectively represent emotional resonance of users to the article. Therefore, if the article published can obtain more response or emotional resonance of the users, it can attract more attention of the users to improve the diffusion effect of the article published.

However, after writing an article, a manager managing the fan pages is generally lack of an effective method for estimating the response (e.g., responses for reflecting emotions, such as loved, sad, happy, scared, angry or the like) that may be obtained after publishing the article so that it is hard for big brand companies, integrated marketing/digital companies, medium operators and public relations companies or the like to evaluate whether the expected response can be achieved during the management of the social networks.

Accordingly, an urgent need exists in the art to provide a technology that is capable of predicting response that may be generated to the content of the article.

### SUMMARY

Provided is an apparatus for predicting response to an article. The apparatus for predicting response to an article can comprise a storage, an input interface and a processor, and the processor is electrically connected to the storage and the input interface. The storage stores a response prediction model, and the input interface is configured to receive an article to be predicted. The processor is configured to analyze the article to be predicted to obtain an article content of the article to be predicted. The processor is further configured to predict a response generated after the article to be predicted is read according to the response prediction model and the article content of the article to be predicted, and generate response data according to the predicted response.

Also provided is a method for predicting response to an article. The method is adapted for an apparatus for predicting response to an article, the apparatus for predicting response to an article comprises a storage, an input interface and a processor, the storage stores a response prediction model, and the input interface is configured to receive an article to be predicted. The method for predicting response to an article is executed by the processor and comprises the following steps: analyzing the article to be predicted to obtain an article content of the article to be predicted; predicting a response generated after the article to be predicted is read according to the response prediction model and the article content of the article to be predicted; and generating response data according to the predicted response.

A technology (at least comprising an apparatus and a method) for predicting response to an article is provided and predicts response that may be generated after an article to be predicted is read via a response prediction model according to an article content of the article to be predicted. The response prediction model is generated by analyzing a large amount of sample articles which have different categories and have been evaluated. Through the aforesaid operation, response that may be generated after an article to be predicted is read can be predicted, thereby solving the problem in the prior art that the possible response to the article cannot be predicted.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic architectural view depicting an apparatus for predicting response to an article according to an embodiment of the present invention;

FIG. 2A is a schematic flowchart diagram of establishing a response prediction model according to an embodiment of the present invention;

FIG. 2B and FIG. 2C respectively depict exemplary examples of estimating weighted emotional values according to an embodiment of the present invention; and

FIG. 3 is a flowchart diagram of a method for predicting response to an article according to a second embodiment of the present invention.

### DETAILED DESCRIPTION

In the following description, the present invention will be explained with reference to certain example embodiments thereof. However, these example embodiments are not intended to limit the present invention to any specific example, embodiment, operations, environment, applications, structures, processes or steps described in these example embodiments.

In the attached drawings, elements unrelated to the present invention are omitted from depiction; and proportional relationships among individual elements in the attached drawings are only for ease of description but not intended to limit the actual scale of the present invention. Unless stated particularly, same (or similar) element symbols may correspond to same (or similar) elements in the following description.

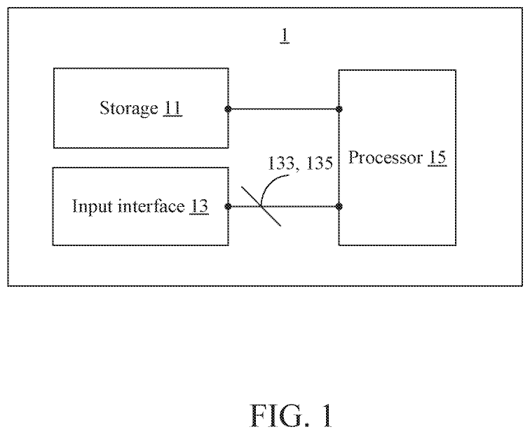

FIG. 1 illustrates an apparatus for predicting response to an article (which is called “a predicting apparatus 1” for short hereinafter) according to some embodiments of the present invention. However, what described in FIG. 1 is only used for describing the embodiment of the present invention instead of limiting the present invention.

Referring to FIG. 1, the predicting apparatus 1 may comprise a storage 11, an input interface 13 and a processor 15, and the processor 15 is electrically connected to the storage 11 and the input interface 13. In addition to the storage 11 and the processor 13, the predicting apparatus 1 may further comprise other elements, which are for example but not limited to an output element, a networked element or the like, in some embodiments. All the elements comprised in the predicting apparatus 1 are connected with each other, and any two of the elements may be connected directly (i.e., connected with each other not via other functional elements) or connected indirectly (i.e., connected with each other via other functional elements). The predicting apparatus 1 may be one of various computing machines capable of calculating, storing, communicating, networking or the like, which are for example but not limited to: a desktop computer, a portable computer, a mobile apparatus or the like.

The storage 11 may comprise a primary memory (which is also called a main memory or internal memory), and the processor 15 may directly read instruction sets stored in the primary memory, and execute these instruction sets if needed. The storage 11 may optionally comprise a secondary memory (which is also called an external memory or auxiliary memory), and the memory at this level may use a data buffer to transmit data stored to the primary memory. For example, the secondary memory may for example be a hard disk, an optical disk or the like, without being limited thereto. The storage 11 may optionally comprise a third-level memory, i.e., a storage device that can be inserted into or pulled out from a computer directly, e.g., a mobile disk. The input interface 13 may be an element capable of receiving input data or any of other interfaces capable of receiving input data and well known to those of ordinary skill in the art.

The processor 15 may comprise a microprocessor or a microcontroller that is configured to perform various operation programs in the predicting apparatus 1. The microprocessor or the microcontroller is a kind of programmable specific integrated circuit that is capable of operating, storing, outputting/inputting or the like. Moreover, the microprocessor or the microcontroller can receive and process various coded instructions, thereby performing various logical operations and arithmetical operations and outputting corresponding operation results.

In the first embodiment of the present invention, the processor 15 receives an article to be predicted to be analyzed by a user via the input interface 13. Next, in order to accurately generate response data (e.g., an emotion that the article to be predicted may cause), the processor 15 analyzes the article to be predicted to acquire an article content of the article to be predicted that is related to the determination of the response data. Finally, the processor 15 predicts response that may be generated after the article to be predicted is read according to the article content of the article to be predicted via a pre-established response prediction model, and generates response data according to the response generated by the response prediction model. The user may know the response that may be generated to the article to be predicted according to the response data. The implementation details related to the present invention will be detailed in the following paragraphs.

In this embodiment, the storage 11 stores a response prediction model (not shown). It shall be appreciated that, the response prediction model may be established by the predicting apparatus 1 itself or may be directly received from an external apparatus, and the establishing method of the response prediction model and the content thereof will be further detailed in later paragraphs.

In this embodiment, the input interface 13 is configured to receive an article 133 to be predicted. Next, when the article 133 to be predicted is received, the processor 15 analyzes the article 133 to be predicted to acquire an article content of the article to be predicted. For example, for a passage of the article to be predicted “many things are hard to be compensated for once they are broken”, the processor 15 analyzes contents that may be related to the response generated after the article 133 to be predictedis read (e.g., retrieves keywords “broken” and “compensated for” that are related to emotions as the article content of the article to be predicted). It shall be appreciated that, the form of the article to be predicted that is retrieved is not limited in the present invention, and it may be a paragraph of sentences, words or any content that is enough to represent the meaning of the text, or the whole content of the article to be predicted may be retrieved as the article content. Moreover, the method of retrieving the article content is not the key point of the present invention, and the contents thereof shall be appreciated by those of ordinary skill in the art and thus will not be further described herein.

Thereafter, the processor 15 predicts a response generated after the article 133 to be predicted is read according to the response prediction model and the article content of the article 133 to be predicted, and generates response data according to the predicted response. For example, the response data generated by the response prediction model may be an emotion (e.g., sad, angry or the like) hit by the article 133 to be predicted, and the user may know the response that may be generated after the article 133 to be predicted is read according to the response data. It shall be appreciated that, the response data may also be an expression symbol, a mood, an emotion or any mode that may be used to evaluate the article content and shall be appreciated by those of ordinary skill in the art, and the claimed scope thereof is not limited by the present invention.

For ease of description, five expression symbols provided by the facebook (which are respectively emotions such as loved, sad, happy, scared, angry or the like) will be used as the basis for establishing the response prediction model, and these expression symbols serve as the content of the response data, and this is only used for ease of illustrating the present invention rather than for limiting the content of the present invention.

In the embodiment where the predicting apparatus 1 establishes the response prediction model by itself, the storage 11 further stores a plurality of first sample articles (e.g., articles collected from various social platforms) and a plurality of sets of emotional values related to the first sample articles respectively (e.g., the number of expression symbols responded by a plurality of users for the articles) for establishing the response prediction model.

The response prediction model may be established according to the following operations. First, in order to determine each of the first sample articles respectively represents which emotion, the processor 15 determines an sentiment label for each of the first sample articles according to the respective set of emotional values. For example, the processor 15 may count the expression symbol that occupies the highest proportion in each of the first sample articles, and use the expression symbol as the sentiment label for representing each of the first sample articles. Next, the processor 15 establishes the response prediction model through machine learning according to the sentiment labels and the first sample articles.

In some embodiments, the processor 15 may perform a word segmentation operation and a part-of-speech tagging operation on each of the first sample articles according to the respective sentiment label to obtain a plurality of specific words. Next, the processor 15 establishes correlations between all the specific words and the sentiment labels through machine learning. Finally, the processor 15 establishes the response prediction model according to the correlations.

For example, the processor 15 performs a word segmentation operation and a part-of-speech tagging operation (e.g., via a jieba word-segmenting device) on a first sample article of which the sentiment label is sad, and filters the content of the first sample article to obtain a plurality of specific words (e.g., words relatively related to the sad emotion). The part-of-speech may comprise particular types of nouns, verbs, adjectives, adverbs or the like which are commonly used as emotional words. Next, for all the specific words of the first sample article, the processor 15 establishes correlations between all the specific words and the sentiment labels through machine learning. For example, if a certain word particularly belongs to a certain sentiment label, then the word has a higher correlation with the sentiment label; and if a certain word is related to more than two sentiment labels at the same time, then the word has a lower correlation with the sentiment labels. After establishing correlations between all the specific words and the sentiment labels through machine learning (e.g., deep learning algorithm), the processor 15 may generate the correspondence relationships between the sentiment labels and the specific words and achieve the purpose of prediction according to these correspondence relationships.

It shall be appreciated that, the form related to the specific word is not limited in the present invention, and the specific word may be a paragraph of sentences, words or any content that can represent the meaning of the article can be retrieved as the specific word. Moreover, those of ordinary skill in the art shall be able to appreciate how to perform the word segmentation operation, the part-of-speech tagging operation and how to establish the correlations according to the machine learning based on the aforesaid content, and thus will not be further described herein.

In some embodiments, the processor 15 further establishes a response prediction model according to an article category of the first sample article. As shown in FIG. 1, when the input interface 13 receives the article 133 to be predicted, the input interface 13 further receives an article category 135 of the article 133 to be predicted, and the response prediction model corresponds to the article category 135. It shall be appreciated that, the article category 135 indicates to which article category (e.g., politics, gender mood, beauty care or the like) the article 133 to be predicted belongs. Because the same words may have different meanings/effects in different article categories, the processor 15 also inputs the article category 135 of the article 133 to be predicted into the response prediction model during the subsequent prediction operation so that the prediction for the article 133 to be predicted is more accurate.

For example, for the sample articles of which the article category is “gender mood”, the processor 15 establishes a response prediction model corresponding to the article category of “gender mood” via machine learning according to the sentiment label of each sample articles and the specific word of each sample articles, and the processor 15 performs the same operations for the sample articles of which the article category is “politics”. Next, after the article content and the article category 135 of the article 133 to be predicted are input, the response prediction model may first determine which article category is related according to the article content and the article category 135 of the article 133 to be predicted, then determine the correlations between the specific word related to the determined article category and the article content of the article 133 to be predicted, and then predict the possible response to the article 133 to be predicted according to the sentiment label corresponding to the specific word. It shall be appreciated that the method of model training shall be appreciated by those of ordinary skill in the art based on the above content, and thus will not be further described herein.

In some embodiments, the storage 15 further stores a plurality of sets of remark messages related to the first sample articles respectively, e.g., text comments made by users for the sample articles or the like. In the aforesaid process of establishing the response prediction model, the processor 15 further determines the sentiment label of each of the first sample articles according to the following operation. First, the processor 15 calculates, for each of the first sample articles, a positive sentiment score, a negative sentiment score and a remark popularity index according to the respective set of remark messages. Then, for each of the first sample articles, the processor 15 calculates a positive sentiment weighted score according to the respective remark popularity index and the respective positive sentiment score and a negative sentiment weighted score according to the respective remark popularity index and the respective negative sentiment score.

Thereafter, for each of the first sample articles, the processor 15 calculates correlations between the respective set of emotional values and the respective positive sentiment score and correlations between the respective set of emotional values and the respective negative sentiment score. Then, for each of the first sample articles, the processor 15 calculates the respective set of emotional values according to the respective correlations, the respective positive sentiment weighted score, the respective negative sentiment weighted score and a set of preset emotional values. Finally, the processor 15 takes the weighted emotional values of each of the first sample articles as the set of emotional values to decide the sentiment label of each of the first sample articles.

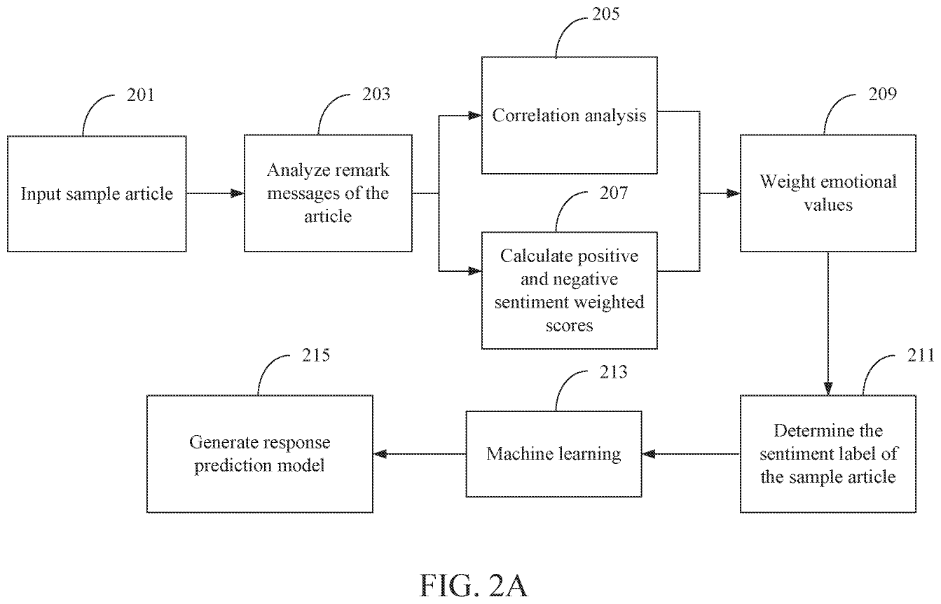

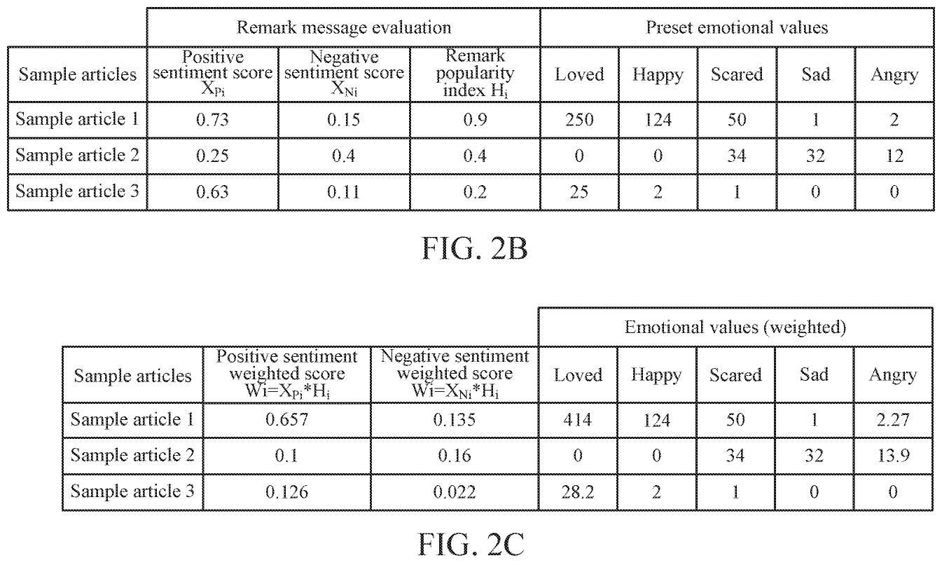

For ease of understanding, FIG. 2A shows a schematic view to depict a flow process of establishing a response prediction model according to an embodiment of the present invention. Referring to FIG. 2A, the processor 15 executes an operation 201 to input a plurality of sample articles. Next, an operation 203 is executed to analyze remark messages of each of the sample articles. Thereafter, the processor 15 respectively executes an operation 205 for correlation analysis and an operation 207 to calculate positive and negative sentiment weighted scores. Next, the processor 15 executes an operation 209 to weight emotional values. Next, the processor 15 executes an operation 211 to determine the sentiment label of each of the sample articles. Finally, the processor 15 executes an operation 213 to perform machine learning and executes an operation 215 to generate a response prediction model.

FIG. 2B and FIG. 2C are taken as an exemplary example for further illustration. FIG. 2B illustrates remark message evaluation (comprising the positive sentiment score X_{Pi}, the negative sentiment score X_{Ni} and the remark popularity index HO and a set of preset/initial emotional values (comprising the number of each expression symbol) corresponding to a sample article 1, a sample article 2 and a sample article 3. The positive sentiment score is a score calculated by the processor 15 that represents the remark messages having positive sentiments of each of the sample articles (e.g., proportions of positive remarks), the negative sentiment score is a score calculated by the processor 15 that represents the remark messages having negative sentiments of each of the sample articles, and the remark popularity index represents the popularity of the remarks (e.g., the proportion occupied by the number of remarks of this article in the total number of the remarks of the sample articles). Next, the processor 15 calculates correlations between the positive sentiment scores and the positive expression symbols (e.g., loved, happy) and correlations between the negative sentiment scores and the negative expression symbols (e.g., sad, angry). For example, the processor 15 calculates the positive correlation between the positive expression symbol “loved” and the positive sentiment score of the sample article 1, the sample article 2 and the sample article 3 and generates a respective correlation value respectively for the sample article 1, the sample article 2 and the sample article 3.

Next, the processor 15 may perform a weighting operation on the expression symbol value having the highest correlation that is larger than a preset threshold respectively in the positive expression symbols and the negative expression symbols. The processor 15 may calculate the positive sentiment weighted score according to the following equation (1) and calculate the negative sentiment weighted score according to the equation (2).

Wᵢ=X_{Pi}×Hᵢ (1)

Wᵢ=X_{Ni}×Hᵢ (2)

In the aforesaid equations (1) and (2), the equation (1) is the positive sentiment weighted score Wᵢ, and the equation (2) is the negative sentiment weighted score Wᵢ. The variant i is the i^{th} article, X_{Pi} is the positive sentiment score of the i^{th} article, X_{Ni} is the negative sentiment score of the i^{th} article, and Hᵢ is the remark popularity index of the i^{th} article.

Taking the sample article 1 as an example, as shown in FIG. 2B, because the processor 15 determines that the correlation of the positive expression symbol “loved” is the highest, the weighting operation is performed on the expression symbol value related to “loved” in the set of emotional values. Because the processor 15 determines that the correlation of the negative expression symbol “angry” is the highest, the weighting operation is performed on the expression symbol value related to “angry” in the set of emotional values. Therefore, as shown in FIG. 2C, the positive sentiment weighted score of the sample article 1 is 0.657 (i.e., 0.73×0.9=0.657), and the expression symbol value of “loved” of the sample article 1 after the weighting operation is 414 (i.e., 250× (1+0.657)=414). Because the expression symbol value of “loved” in the emotional values after the weighting operation is the highest, the processor 15 may determine the sentiment label of the sample article 1 as “loved”.

In some embodiments, the response data generated by the processor 15 further comprises a plurality of reliance score and a plurality of sets of emotional words related to the reliance score respectively. The reliance score may be configured to evaluate the strength of the prediction. For example, the response data may comprise “sad”, “angry” and “happy”, which respectively correspond to reliance score of 85, 75 and 30, and these reliance score indicate that it is more possible for the article to be predicted to have response of “sad” and “angry”. Additionally, the user may also preset an reliance score threshold so that the response prediction model only outputs results larger than the reliance score threshold.

Additionally, in some embodiments, the storage 11 further stores an emotional keyword recommendation model. The input interface 13 further receives a response target (e.g., an emotion that the user wishes to be hit by the article to be predicted). Next, the processor 15 determines whether the response data matches with the response target. If the response data does not match with the response target, the processor 15 generates recommendation data according to the emotional keyword recommendation model, wherein the recommendation data is related to the response target. For example, if the user wishes the article to be predicted to hit the emotion of sad, and the emotion obtained by predicting the article 133 to be predicted does not match with the expected “sad”, the processor 15 may recommend the emotional keywords related to sad (e.g., “dispirited”, “crying”) according to the emotional keyword recommendation model so as to assist the user in writing the article.

It shall be appreciated that the emotional keyword recommendation model may be established by the predicting apparatus 1 itself or may be directly received from an external apparatus. In the embodiment where the emotional keyword recommendation model is established by the predicting apparatus 1 itself, the emotional keyword recommendation model is established by the following operations. The storage 11 further stores a plurality of second sample articles and a plurality of sets of emotional values related to the second sample articles respectively. Next, the processor 15 determines an sentiment label for each of the second sample articles according to the respective set of emotional values. The processor 15 establishes the emotional keyword recommendation model through machine learning according to the sentiment labels and the second sample articles. It shall be appreciated that, in some embodiments, the processor 15 may also select the emotional keywords by adding parameters such as the word frequency, expectation factor or the like. It shall be appreciated that the second sample article is not limited to be the same as the first sample article by the present invention, and the content of the sample articles may be determined depending on requirements thereof.

In some embodiments, the processor 15 performs a word segmentation operation and a part-of-speech tagging operation on each of the second sample articles according to the respective sentiment label to obtain a plurality of specific words. Next, the processor 15 may establish correlations between all the specific words and the sentiment labels according to the aforesaid computing method. In this embodiment, the correlation may not be established by using the machine learning scheme, but by performing a weighting operation according to the number of the second sample articles with the same sentiment label that having the keywords and the occurrence frequency of the keyword, thereby calculating an expectation value of stimulating a certain emotion by the keyword and accordingly establishing the correlation. Finally, the processor 15 establishes the emotional keyword recommendation model according to the correlations. Specifically, the aforesaid response predication model is to input an article content of an article to be predicted and predict a response generated after the article to be predicted is read according to the article content, and the emotional keyword recommendation model is to input a response target and generate recommendation data (e.g., emotional keywords) related to the response target according to the response target. Those of ordinary skill in the art shall be able to appreciate the establishing method of the emotional keyword recommendation model based on the aforesaid establishing method of the response prediction model, and thus will not be further described herein.

In some embodiments, the response prediction model and the emotional keyword recommendation model may be integrated into a single model, and the single model is established according to a plurality of first reference articles. In some embodiments, the response prediction model and the emotional keyword recommendation model are two independent models, the response prediction model is established according to a plurality of first reference articles and the emotional keyword recommendation model is established according to a plurality of second reference articles.

In some embodiments, the recommendation data comprises at least one of keywords, articles and articles posting modes that match with the response target. For example, in addition to recommending the emotional keywords related to “sad”, the processor 15 may further recommend a sample article having the emotional keywords or an article posting mode thereof according to the emotional keyword recommendation model, thereby assisting the user in writing the article.

As can be known from the above description, a technology for predicting response to an article provided by the present invention predicts response that may be generated after an article to be predicted is read via a response prediction model according to an article content of the article to be predicted. The response prediction model is generated by analyzing a large amount of sample articles which have different categories and have been evaluated. Thus, through the aforesaid operation, response that may be generated after the article to be predicted is read can be predicted, thereby solving the problem in the prior art that the possible response to the article cannot be predicted. Additionally, when the article to be predicted does not match with the expected response target of the user, the present invention further provides a recommendation technology to provide the user with the recommendation data related to the response target, thereby assisting the user in writing the article.

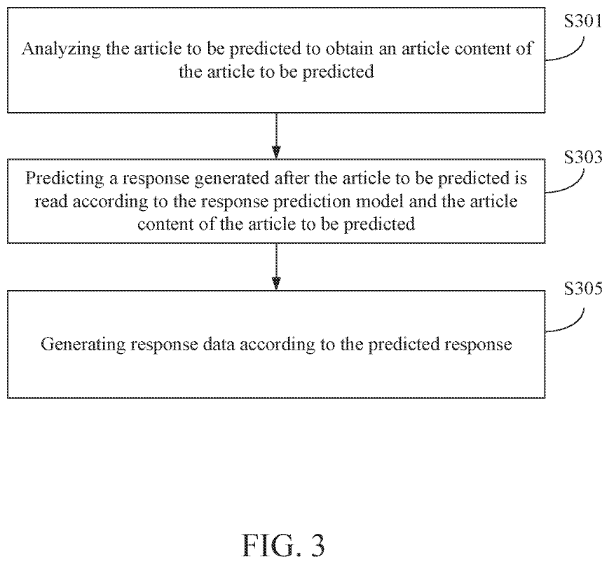

A second embodiment of the present invention is a method for predicting response to an article, and a flowchart diagram thereof is depicted in FIG. 3. The method for predicting response to an article is adapted for use in an apparatus 1 for predicting response to an article described in the first embodiment. The apparatus for predicting response to an article comprises a storage, an input interface and a processor, the storage stores a response prediction model (e.g., the response prediction model of the first embodiment), the input interface is configured to receive an article to be predicted, and the method for predicting response to an article is executed by the processor. The method for predicting response to an article generates response data via steps S301 to S305.

In step S301, the article to be predicted is analyzed by the electronic apparatus to obtain an article content of the article to be predicted. Next, in step S303, a response generated after the article to be predicted is read is predicted by the electronic apparatus according to the response prediction model and the article content of the article to be predicted. Thereafter, in step S305, response data is generated by the electronic apparatus according to the predicted response.

The order of steps S301, S303 and S305 shown in FIG. 3 is not limited. The order may be adjusted while it is still capable of implementing the present invention.

In some embodiments, the method for predicting response to an article further comprises a step of receiving an article category of the article to be predicted via the input interface, and the response prediction model corresponds to the article category.

In some embodiments, the storage further stores a plurality of first sample articles and a plurality of sets of emotional values related to the first sample articles respectively. In addition to the steps S301, S303 and S305, the method for predicting response to an article further comprises the following steps: determining an sentiment label for each of the first sample articles according to the respective set of emotional values; and establishing the response prediction model through machine learning according to the sentiment labels and the first sample articles.

In some embodiments, the method for predicting response to an article further comprises the following steps: performing a word segmentation operation and a part-of-speech tagging operation on each of the first sample articles according to the respective sentiment label to obtain a plurality of specific words; establishing correlations between all the specific words and the sentiment labels through machine learning; and establishing the response prediction model according to the correlations.

In some embodiments, the storage further stores a plurality of sets of remark messages related to the first sample articles respectively, and the method for predicting response to an article further comprises the following steps: calculating, for each of the first sample articles, a positive sentiment score, a negative sentiment score and a remark popularity index according to the respective set of remark messages; calculating, for each of the first sample articles, a positive sentiment weighted score according to the respective remark popularity index and the respective positive sentiment score and a negative sentiment weighted score according to the respective remark popularity index and the respective negative sentiment score; calculating, for each of the first sample articles, correlations between the respective set of emotional values and the respective positive sentiment score and correlations between the respective set of emotional values and the respective negative sentiment score; and calculating, for each of the first sample articles, the respective set of emotional values according to the respective correlations, the respective positive sentiment weighted score, the respective negative sentiment weighted score and a set of preset emotional values.

In some embodiments, the response data comprises a plurality of reliance score and a plurality of sets of emotional words related to the reliance score respectively.

In some embodiments, the storage is further configured to store an emotional keyword recommendation model, the input interface is further configured to receive a response target, and the method for predicting response to an article further comprises the following steps: determining whether the response data matches with the response target; and if the response data does not match with the response target, generating recommendation data according to the emotional keyword recommendation model, wherein the recommendation data is related to the response target.

In some embodiments, the storage further stores a plurality of second sample articles and a plurality of sets of emotional values related to the second sample articles respectively, and the method for predicting response to an article further comprises the following steps: determining an sentiment label for each of the second sample articles according to the respective set of emotional values; and establishing the emotional keyword recommendation model through machine learning according to the sentiment labels and the second sample articles.

In some embodiments, the method for predicting response to an article further comprises the following steps: performing a word segmentation operation and a part-of-speech tagging operation on each of the second sample articles according to the respective sentiment label to obtain a plurality of specific words; establishing correlations between all the specific words and the sentiment labels through machine learning; and establishing the emotional keyword recommendation model according to the correlations.

In some embodiments, the recommendation data comprises at least one of keywords, an articles and articles posting modes that match with the response target.

In addition to the aforesaid steps, the second embodiment can also execute all the operations and steps of the predicting apparatus 1 set forth in the first embodiment, have the same functions and deliver the same technical effects as the first embodiment. How the second embodiment executes these operations and steps, has the same functions and delivers the same technical effects as the first embodiment will be readily appreciated by those of ordinary skill in the art based on the explanation of the first embodiment, and thus will not be further described herein.

It shall be appreciated that, in the specification and the claims of the present invention, some words (e.g., sample article) are preceded by terms such as “first” or “second”, and these terms of “first” and “second” are only used to distinguish these different words.

According to the above descriptions, a technology (at least comprising the apparatus and the method) for predicting response to an article provided by the present invention predicts response that may be generated after an article to be predicted is read via a response prediction model according to an article content of the article to be predicted. The response prediction model is generated by analyzing a large amount of sample articles which have different categories and have been evaluated. Thus, through the aforesaid operation, response that may be generated after the article to be predicted is read can be predicted, thereby solving the problem in the prior art that the possible response to the article cannot be predicted. Additionally, when the article to be predicteddoes not match with the expected response target of the user, the present invention further provides a recommendation technology to provide the user with the recommendation data related to the response target, thereby assisting the user in writing the article.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for predicting response to an article, comprising:
a storage, being configured to store a response prediction model;
an input interface, being configured to receive an article to be predicted; and
a processor, being electrically connected to the storage and the input interface, and being configured to:
analyze the article to be predicted to obtain an article content of the article to be predicted; and
predict a response generated after the article to be predicted is read according to the response prediction model and the article content of the article to be predicted, and generate response data according to the predicted response.

2. The apparatus for predicting response to an article of claim 1, wherein the input interface is further configured to receive an article category of the article to be predicted and the response prediction model corresponds to the article category.

3. The apparatus for predicting response to an article of claim 1, wherein the storage further stores a plurality of first sample articles and a plurality of sets of emotional values related to the first sample articles respectively, and the processor is further configured to:
determine an sentiment label for each of the first sample articles according to the respective set of emotional values; and
establish the response prediction model through machine learning according to the sentiment labels and the first sample articles.

4. The apparatus for predicting response to an article of claim 3, wherein the processor is further configured to:
perform a word segmentation operation and a part-of-speech tagging operation on each of the first sample articles according to the respective sentiment label to obtain a plurality of specific words;
establish correlations between all the specific words and the sentiment labels through machine learning; and
establish the response prediction model according to the correlations.

5. The apparatus for predicting response to an article of claim 3, wherein the storage further stores a plurality of sets of remark messages related to the first sample articles respectively, and the processor is further configured to:
calculate, for each of the first sample articles, a positive sentiment score, a negative sentiment score and a remark popularity index according to the respective set of remark messages;
calculate, for each of the first sample articles, a positive sentiment weighted score according to the respective remark popularity index and the respective positive sentiment score and a negative sentiment weighted score according to the respective remark popularity index and the respective negative sentiment score;
calculate, for each of the first sample articles, correlations between the respective set of emotional values and the respective positive sentiment score and correlations between the respective set of emotional values and the respective negative sentiment score; and
calculate, for each of the first sample articles, the respective set of emotional values according to the respective correlations, the respective positive sentiment weighted score, the respective negative sentiment weighted score and a set of preset emotional values.

6. The apparatus for predicting response to an article of claim 1, wherein the response data comprises a plurality of reliance score and a plurality of sets of emotional words related to the reliance score respectively.

7. The apparatus for predicting response to an article of claim 1, wherein:
the storage is further configured to store an emotional keyword recommendation model;
the input interface is further configured to receive a response target; and
the processor is further configured to:
determine whether the response data matches with the response target; and
if the response data does not match with the response target, generate recommendation data according to the emotional keyword recommendation model, wherein the recommendation data is related to the response target.

8. The apparatus for predicting response to an article of claim 7, wherein the storage further stores a plurality of second sample articles and a plurality of sets of emotional values related to the second sample articles respectively, and the processor is further configured to:
determine an sentiment label for each of the second sample articles according to the respective set of emotional values; and
establish the emotional keyword recommendation model through machine learning according to the sentiment labels and the second sample articles.

9. The apparatus for predicting response to an article of claim 8, wherein the processor is further configured to:
perform a word segmentation operation and a part-of-speech tagging operation on each of the second sample articles according to the respective sentiment label to obtain a plurality of specific words;
establish correlations between all the specific words and the sentiment labels through machine learning; and
establish the emotional keyword recommendation model according to the correlations.

10. The apparatus for predicting response to an article of claim 7, wherein the recommendation data comprises at least one of keywords, articles and articles posting modes that match with the response target.

11. A method for predicting response to an article, which is adapted for an apparatus for predicting response to an article, the apparatus for predicting response to an article comprising a storage, an input interface and a processor, the storage storing a response prediction model, the input interface being configured to receive an article to be predicted, the method for predicting response to an article being executed by the processor and comprising:
analyzing the article to be predicted to obtain an article content of the article to be predicted; and
predicting a response generated after the article to be predicted is read according to the response prediction model and the article content of the article to be predicted, and generating response data according to the predicted response.

12. The method for predicting response to an article of claim 11, further comprising:
receiving an article category of the article to be predicted via the input interface, wherein the response prediction model corresponds to the article category.

13. The method for predicting response to an article of claim 11, wherein the storage further stores a plurality of first sample articles and a plurality of sets of emotional values related to the first sample articles respectively, and the method for predicting response to an article further comprises:
determining an sentiment label for each of the first sample articles according to the respective set of emotional values; and
establishing the response prediction model through machine learning according to the sentiment labels and the first sample articles.

14. The method for predicting response to an article of claim 13, further comprising:
performing a word segmentation operation and a part-of-speech tagging operation on each of the first sample articles according to the respective sentiment label to obtain a plurality of specific words;
establishing correlations between all the specific words and the sentiment labels through machine learning; and
establishing the response prediction model according to the correlations.

15. The method for predicting response to an article of claim 13, wherein the storage further stores a plurality of sets of remark messages related to the first sample articles respectively, and the method for predicting response to an article further comprises:
calculating, for each of the first sample articles, a positive sentiment score, a negative sentiment score and a remark popularity index according to the respective set of remark messages;
calculating, for each of the first sample articles, a positive sentiment weighted score according to the respective remark popularity index and the respective positive sentiment score and a negative sentiment weighted score according to the respective remark popularity index and the respective negative sentiment score;
calculating, for each of the first sample articles, correlations between the respective set of emotional values and the respective positive sentiment score and correlations between the respective set of emotional values and the respective negative sentiment score; and
calculating, for each of the first sample articles, the respective set of emotional values according to the respective correlations, the respective positive sentiment weighted score, the respective negative sentiment weighted score and a set of preset emotional values.

16. The method for predicting response to an article of claim 11, wherein the response data comprises a plurality of reliance score and a plurality of sets of emotional words related to the reliance score respectively.

17. The method for predicting response to an article of claim 11, wherein the storage is further configured to store an emotional keyword recommendation model, the input interface is further configured to receive a response target, and the method for predicting response to an article further comprises:
determining whether the response data matches with the response target; and
if the response data does not match with the response target, generating recommendation data according to the emotional keyword recommendation model, wherein the recommendation data is related to the response target.

18. The method for predicting response to an article of claim 17, wherein the storage further stores a plurality of second sample articles and a plurality of sets of emotional values related to the second sample articles respectively, and the method for predicting response to an article further comprises:
determining an sentiment label for each of the second sample articles according to the respective set of emotional values; and
establishing the emotional keyword recommendation model through machine learning according to the sentiment labels and the second sample articles.

19. The method for predicting response to an article of claim 18, further comprising:
performing a word segmentation operation and a part-of-speech tagging operation on each of the second sample articles according to the respective sentiment label to obtain a plurality of specific words;
establishing correlations between all the specific words and the sentiment labels through machine learning; and
establishing the emotional keyword recommendation model according to the correlations.

20. The method for predicting response to an article of claim 17, wherein the recommendation data comprises at least one of keywords, articles and articles posting modes that match with the response target.
